(19) United States
(12) Patent Application Publication
(10) Pub. No.: US 2022/0292893 A1
(43) Pub. Date: Sep. 15, 2022

(54) VEHICLE-MOUNTED RELAY DEVICE, COMPUTER PROGRAM, AND FAILURE DETERMINING METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Yuki SANO, Yokkaichi-shi, Mie (JP)

(21) Appl. No.: 17/597,986

(22) PCT Filed: Jul. 28, 2020
(86) PCT No.: PCT/JP2020/028937

§ 371 Date: Jan. 31, 2022

(30) Foreign Application Priority Data
Aug. 2, 2019 (JP) 2019-143159

(51) Int. Cl. G07C 5/08; B60W 50/12

(52) U.S. Cl. CPC G07C 5/0816; G07C 5/0841; B60W 50/12; B60W 2510/305

(57) ABSTRACT

Provided are a vehicle-mounted relay device, a computer program, and a failure determining method capable of determining the presence of a failure in a vehicle-mounted device. The vehicle-mounted relay device includes: a power relay unit; a sensing unit that senses a power consumption; a communication relay unit that relays transmission and reception of data; and a failure determining unit that determines the presence or absence of a failure. The vehicle-mounted relay device may include a cutoff unit cutting off the power to the vehicle-mounted device from the power relay unit when a failure is determined to be present on the basis of the power consumption amount sensed. The vehicle-mounted relay device may include a limiting unit that limits the relay of data from the vehicle-mounted device to another device when a failure is determined to be present on the basis of the data transmitted being an abnormal value.

### CROSS-REFERENCE TO RELATED APPLICATIONS

This application is the U.S. national stage of PCT/JP2020/028937 filed on Jul. 28, 2020, which claims priority of Japanese Patent Application No. JP 2019-143159 filed on Aug. 2, 2019, the contents of which are incorporated herein.

### TECHNICAL FIELD

The present disclosure relates to a vehicle-mounted relay device, a computer program, and a failure determining method that relay a supply of power from a power source mounted in a vehicle to a vehicle-mounted device, relay transmission and reception of data to and from the vehicle-mounted device, and determine the presence or absence of a failure in the vehicle-mounted device.

### BACKGROUND

The number of Electronic Control Units (ECUs) installed in vehicles has been increasing in recent years. Each ECU communicates with other ECUs to exchange information therewith, and each performs its own processing. Accordingly, as the number of ECUs in a vehicle increases, the amount of communication lines in the vehicle provided for the ECUs to communicate increases as well, which risks increasing the weight of the vehicle, reducing the space for running the communication lines in the vehicle, and the like.

JP 2015-67187A describes a vehicle control system in which the interior of a vehicle is divided into a plurality of regions, a plurality of function ECUs in each region are connected to a relay ECU over a first network, and a plurality of relay ECUs are connected over a second network.

It is desirable to quickly detect and respond to failures, abnormalities, and the like in various types of devices mounted in a vehicle.

Having been conceived of in light of the above-described circumstances, an object of the present disclosure is to provide a vehicle-mounted relay device, a computer program, and a failure determining method capable of detecting the presence or absence of a failure in a vehicle-mounted device.

### SUMMARY

A vehicle-mounted relay device according to an embodiment includes: a power relay unit that relays power from a power source mounted in a vehicle to a vehicle-mounted device; a sensing unit that senses a power consumption amount of the vehicle-mounted device; a communication relay unit that relays transmission and reception of data to and from the vehicle-mounted device; and a failure determining unit that determines the presence or absence of a failure in the vehicle-mounted device in accordance with data transmitted by the vehicle-mounted device and the power consumption amount sensed by the sensing unit.

The present application can be realized not only as a vehicle-mounted relay device and the like including such characteristic processing units, but also as a failure determining method that takes the characteristic processes as steps, a computer program for causing a computer to execute such steps, and so on. The present application can be realized as a semiconductor integrated circuit that implements some or all of these devices, and as another device or system that includes these devices.

### Advantageous Effects of Invention

According to the foregoing, the presence or absence of a failure in a vehicle-mounted device can be determined.

### BRIEF DESCRIPTION OF DRAWINGS

FIG. 1 is a schematic diagram illustrating an overview of a vehicle-mounted communication system according to an embodiment.

FIG. 2 is a schematic diagram illustrating an overview of the vehicle-mounted communication system according to an embodiment.

FIG. 3 is a block diagram illustrating the configuration of a second relay device according to an embodiment.

FIG. 4 is a block diagram illustrating the configuration of a power relay unit according to an embodiment.

FIG. 5 is a schematic diagram illustrating an example of a determination table according to an embodiment.

FIG. 6 is a flowchart illustrating the sequence of failure determination processing performed by the second relay device according to an embodiment.

FIG. 7 is a flowchart illustrating the sequence of failure determination processing performed by the second relay device according to a variation.

FIG. 8 is a flowchart illustrating the sequence of failure determination processing performed by the second relay device according to a variation.

FIG. 9 is a schematic diagram illustrating an overview of a vehicle-mounted communication system according to a second embodiment.

FIG. 10 is a flowchart illustrating the sequence of failure determination processing performed by a second relay device according to the second embodiment.

### DETAILED DESCRIPTION OF PREFERRED EMBODIMENT

First, embodiments of the present disclosure will be described as examples. The embodiments described hereinafter may be at least partially combined as desired.

A vehicle-mounted relay device according to one embodiment includes: a power relay unit that relays power from a power source mounted in a vehicle to a vehicle-mounted device; a sensing unit that senses a power consumption amount of the vehicle-mounted device; a communication relay unit that relays transmission and reception of data to and from the vehicle-mounted device; and a failure determining unit that determines the presence or absence of a failure in the vehicle-mounted device in accordance with data transmitted by the vehicle-mounted device and the power consumption amount sensed by the sensing unit.

According to this embodiment, power from a power source such as a battery, an alternator, or the like mounted in the vehicle is supplied to the vehicle-mounted relay device, and the vehicle-mounted relay device relays the power from the power source to the vehicle-mounted device. The vehicle-mounted relay device relays the data transmitted from the vehicle-mounted device to other vehicle-mounted devices, and the data transmitted to the vehicle-mounted device from other vehicle-mounted devices. In other words, the vehicle-mounted relay device according to this embodiment is a device that relays power and relays communication. The vehicle-mounted relay device senses the power consumption amount of the vehicle-mounted device, and determines the presence or absence of a failure in the vehicle-mounted device in accordance with the data transmitted by the vehicle-mounted device and the power consumption amount of the vehicle-mounted device. This is expected to enable the vehicle-mounted relay device, which relays power and data to the vehicle-mounted device, to accurately determine the presence or absence of a failure in the vehicle-mounted device.

Preferably, the failure determining unit determines that a failure is present when the power consumption amount sensed by the sensing unit is an abnormal value, regardless of whether or not the data transmitted by the vehicle-mounted device is a normal value; determines that a failure is present when the power consumption amount sensed by the sensing unit is a normal value and the data transmitted by the vehicle-mounted device is an abnormal value; and determines that a failure is absent when the power consumption amount sensed by the sensing unit is a normal value and the data transmitted by the vehicle-mounted device is a normal value.

According to this embodiment, when the power consumption amount of the vehicle-mounted device is an abnormal value, the vehicle-mounted relay device determines that the vehicle-mounted device has failed regardless of whether the data transmitted by the vehicle-mounted device is normal or abnormal. Additionally, when the power consumption amount of the vehicle-mounted device is a normal value and the data transmitted by the vehicle-mounted device is an abnormal value, the vehicle-mounted relay device determines that the vehicle-mounted device has failed. In contrast, when the power consumption amount of the vehicle-mounted device is a normal value and the data transmitted by the vehicle-mounted device is a normal value, the vehicle-mounted relay device determines that the vehicle-mounted device has not failed. This is expected to enable the vehicle-mounted relay device to accurately determine the presence or absence of a failure in the vehicle-mounted device on the basis of the data transmitted by the vehicle-mounted device and the power consumption amount of the vehicle-mounted device.

Preferably, the vehicle-mounted relay device further includes a cutoff unit that cuts off the power to the vehicle-mounted device from the power relay unit when a failure is determined to be present on the basis of the power consumption amount sensed by the sensing unit being an abnormal value.

According to this embodiment, when it is determined that there is a failure on the basis of the power consumption amount of the vehicle-mounted device being an abnormal value, the vehicle-mounted relay device blocks the supply of power to the vehicle-mounted device. This makes it possible to prevent abnormal power consumption by the vehicle-mounted device determined to have failed and thus prevent other vehicle-mounted devices mounted in the vehicle from being negatively affected.

Preferably, the vehicle-mounted relay device further includes a limiting unit that limits the relay of data from the vehicle-mounted device to another device when a failure is determined to be present on the basis of the data transmitted by the vehicle-mounted device being an abnormal value.

According to this embodiment, when a failure is determined to be present on the basis of the data transmitted by the vehicle-mounted device being an abnormal value, the vehicle-mounted relay device limits the relay of the data from that vehicle-mounted device to other vehicle-mounted devices. This makes it possible to prevent the other vehicle-mounted devices from malfunctioning or the like due to the abnormal data transmitted by the vehicle-mounted device determined to have failed.

Preferably, the failure determining unit determines that a failure is absent when the power consumption amount sensed by the sensing unit is a normal value and the data transmitted by the vehicle-mounted device is a fail-safe value.

According to this embodiment, when the power consumption amount of the vehicle-mounted device is a normal value and the data transmitted by the vehicle-mounted device is a fail-safe value, the vehicle-mounted relay device determines that the vehicle-mounted device has not failed. The vehicle-mounted device transmitting data having a fail-safe value indicates that even if some abnormality has occurred, the vehicle-mounted device is normally outputting a fail-safe value, and it is therefore highly likely that no failure is occurring.

Preferably, the failure determining unit determines that a failure is present when the power consumption amount sensed by the sensing unit is a normal value and data from the vehicle-mounted device is not received.

According to this embodiment, when the power consumption amount of the vehicle-mounted device is a normal value and no data is received from the vehicle-mounted device, the vehicle-mounted relay device determines that the vehicle-mounted device has failed. If no data is received from the vehicle-mounted device, it is highly likely that there is some sort of failure in the vehicle-mounted device.

A computer program according to one embodiment causes a computer, which includes a power relay unit that relays power from a power source mounted in a vehicle to a vehicle-mounted device and a communication relay unit that relays transmission and reception of data to and from the vehicle-mounted device, to execute the processing of: obtaining a result of sensing a power consumption amount of the vehicle-mounted device; and determining the presence or absence of a failure in the vehicle-mounted device in accordance with data transmitted by the vehicle-mounted device and the power consumption amount obtained.

According to this embodiment, like Embodiment (1), this is expected to enable the accurate determination of the presence or absence of a failure in the vehicle-mounted device.

A failure determining method according to one embodiment includes: relaying power from a power source mounted in a vehicle to a vehicle-mounted device; sensing a power consumption amount of the vehicle-mounted device; relaying transmission and reception of data to and from the vehicle-mounted device; and determining the presence or absence of a failure in the vehicle-mounted device in accordance with data transmitted by the vehicle-mounted device and the power consumption amount sensed.

According to this embodiment, like the first Embodiment, this is expected to enable the accurate determination of the presence or absence of a failure in the vehicle-mounted device.

A specific example of the vehicle-mounted relay device according to embodiments of the present disclosure will be described hereinafter with reference to the drawings. The present disclosure is not intended to be limited to these examples, and is defined instead by the scope of the appended claims. All changes that fall within the same essential spirit as the scope of the claims are intended to be included therein as well.

### System Overview

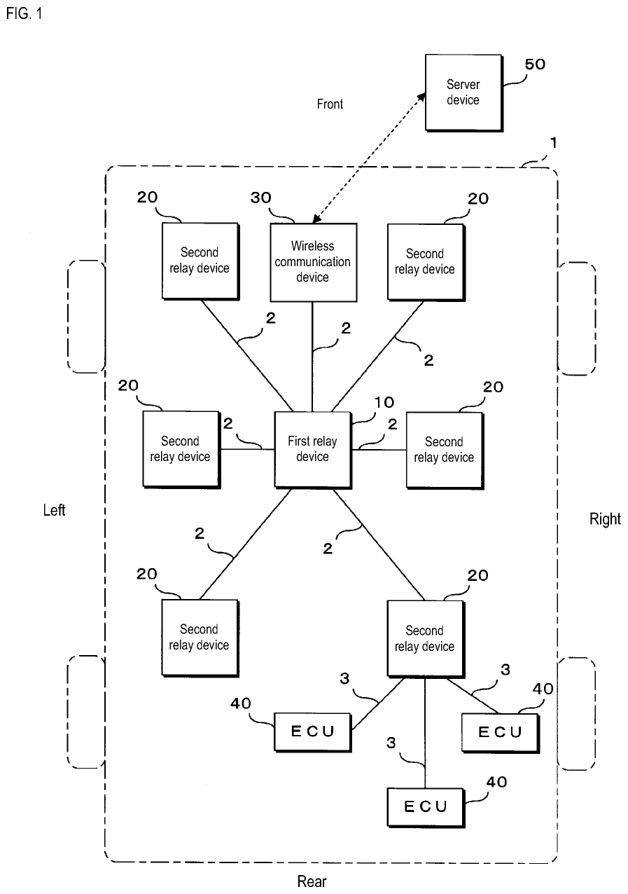

FIG. 1 is a schematic diagram illustrating an overview of the vehicle-mounted communication system according to the present embodiment. FIG. 1 illustrates a network configuration for communication in a vehicle 1. The vehicle-mounted communication system according to the present embodiment is configured including a first relay device 10, a plurality of second relay devices (vehicle-mounted relay devices) 20, a wireless communication device 30, and a plurality of ECUs (vehicle-mounted devices) 40, which are mounted in the vehicle 1. The up-down direction in FIG. 1 is a front-back direction of the vehicle 1, and the left-right direction in FIG. 1 is a left-right direction of the vehicle 1. Note that the number of devices included in the vehicle-mounted communication system, the number of communication lines, the manner in which the devices are connected, the network configuration, and the like are not limited to those illustrated in the drawings.

The vehicle-mounted communication system according to the present embodiment is a system employing a star-type network configuration, in which the plurality of second relay devices 20 and the single wireless communication device 30 are each connected to the first relay device 10 by a communication line 2. In the present embodiment, communication among the first relay device 10, the second relay devices 20, and the wireless communication device 30 over the communication lines 2 is performed according to a communication standard such as Ethernet (registered trademark), Controller Area Network (CAN), or the like. The first relay device 10 performs processing for relaying the transmission and reception of data between the plurality of second relay devices 20 and the wireless communication device, i.e., the transmission and reception of data among the plurality of communication lines 2 connected to the first relay device 10 itself. Note that the communication over the communication lines 2 is not limited to the Ethernet or CAN communication standards, and various other communication standards such as, for example, CAN-FD (CAN with Flexible Data-rate), FlexRay, or the like can be employed.

In the vehicle-mounted communication system according to the present embodiment, the first relay device 10 is mounted in the center of the vehicle 1, and the second relay devices 20 are mounted in six locations of the vehicle 1, namely a right-front part, a right-center part, a right-rear part, a left-front part, a left-center part, and a left-rear part. One or more ECUs 40 disposed in the vicinity of each second relay device 20 is connected to that relay device 20 by a communication line 3. In other words, in the vehicle-mounted communication system according to the present embodiment, a plurality of ECUs 40 are grouped on the basis of their mounting positions in the vehicle 1, and a plurality of ECUs 40 within the group are connected to a single second relay device 20. The plurality of second relay devices 20 are connected to the first relay device 10, and the first relay device 10 performs communication among the groups.

In the present embodiment, the second relay device 20 and the plurality of ECUs 40 are connected by individual communication lines 3, and constitute a star-type network. The communication between the second relay device 20 and the ECUs 40 over the communication lines 3 is performed according to a communication standard such as Ethernet, CAN, or the like. Although FIG. 1 illustrates a configuration in which the ECUs 40 are connected by the communication lines 3 only to the second relay device 20 mounted in the right-rear part of the vehicle 1, this is only for the purpose of simplifying the drawing. In reality, one or more of the communication lines 3 are connected to the other second relay devices 20 as well, and one or more of the ECUs 40 are connected by the communication lines 3. Additionally, the communication over the communication lines 3 is not limited to the Ethernet or CAN communication standards, and various other communication standards may be employed.

In this example, three of the communication lines 3 are connected to the second relay device 20 in the right-rear part, and a single ECU 40 is connected to each communication line 3. The second relay device 20 relays data, which has been transmitted by the ECU 40 connected to one of the communication lines 3, to the other communication lines 3 and to the communication line 2. The second relay device 20 may determine the relay destination of the data on the basis of, for example, identification information attached to the received data, e.g., a CANID or the like. In this case, the second relay device 20 stores, in advance, information such as a table which associates the CANIDs attached to data with relay destination communication lines.

The wireless communication device 30 can transmit and receive data to and from a server device 50 located outside the vehicle 1 by performing communication using a wireless network such as, for example, a mobile phone communication network, wireless LAN (Local Area Network), or the like. As described above, the wireless communication device 30 is connected to the first relay device 10 by the communication line 2, and the first relay device 10 relays the transmission and reception of data between the wireless communication device 30 and the second relay devices 20. Accordingly, each of the ECUs 40 mounted in the vehicle 1 can transmit and receive data to and from the server device 50 outside the vehicle 1 via the wireless communication device 30, the first relay device 10, and the second relay devices 20.

The ECUs 40 include a variety of ECUs, such as, for example, ECUs that control the operations of an engine of the vehicle 1, ECUs that control the locking and unlocking doors, ECUs that control the turning on and off of lights, ECUs that control the operations of airbags, ECUs that control operations of an Antilock Brake System (ABS), and the like. Although the present embodiment describes the ECUs 40 as various devices mounted in the vehicle 1, the vehicle-mounted devices are not limited to ECUs, and may be a variety of other devices.

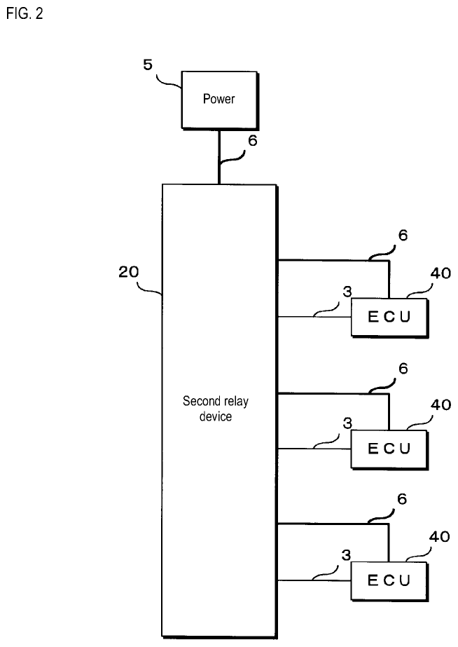

FIG. 2 is a schematic diagram illustrating an overview of the vehicle-mounted communication system according to the present embodiment. FIG. 2 illustrates communication paths and power supply paths between the second relay device 20 and the ECUs 40, focusing on one of the second relay devices 20 included in the vehicle-mounted communication system illustrated in FIG. 1. In FIG. 2, power lines 6 indicated by the bold lines are the power supply paths. A power source 5 such as a battery, an alternator, or the like is mounted in the vehicle 1. The second relay device 20 is connected to the power source 5 by the power lines 6. The power source 5 supplies power to the second relay device 20. Although it is assumed in this example that power is supplied directly to the second relay devices 20 from the power source 5, the configuration is not limited thereto. For example, power may be supplied to the first relay device 10 from the power source 5, and the first relay device 10 may supply the power to the second relay device 20. The configuration may be such that one or more devices are present between the power source 5 and the second relay device 20, and the second relay device 20 receives the supply of power from the power source 5 indirectly.

In this example, three of the communication lines 3 are connected to the second relay device 20. An ECU 40 is connected to each of the communication lines 3. Additionally, the power lines 6 are connected individually between the second relay device 20 and each of the ECUs 40. The second relay device 20 converts the power supplied from the power source 5, which has, for example, a voltage value of 12 V, to power of 5 V 3 V, or the like, and supplies the power to each ECU 40 individually via the power lines 6.

In the vehicle-mounted communication system according to the present embodiment, the second relay device 20 performs processing for determining the presence or absence of a failure in an ECU 40 connected to the second relay device 20 itself. The second relay device 20 according to the present embodiment determines the presence or absence of a failure in each ECU 40 on the basis of data transmitted by each ECU 40 and a power consumption amount of each ECU 40.

### Apparatus Configuration

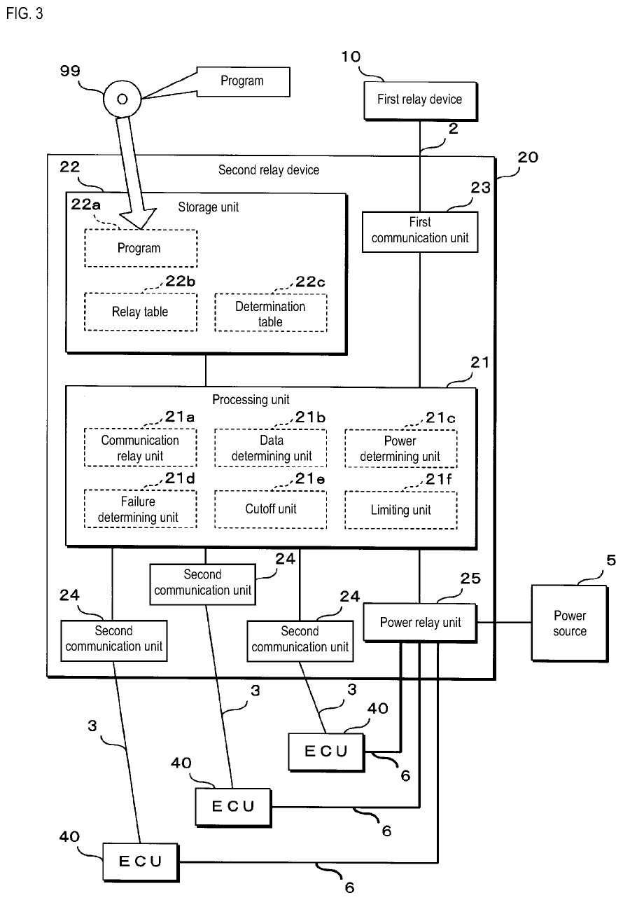

FIG. 3 is a block diagram illustrating the configuration of the second relay device 20 according to the present embodiment. The second relay device 20 according to the present embodiment is configured including a processing unit (processor) 21, a storage unit (storage) 22, a first communication unit (transceiver) 23, three second communication units (transceivers) 24, and a power relay unit 25. The processing unit 21 is configured using, for example, an arithmetic processing device such as a Central Processing Unit (CPU), a Micro-Processing Unit (MPU), or the like. The processing unit 21 can perform various types of processing by reading out and executing programs stored in the storage unit 22. In the present embodiment, the processing unit 21 performs processing for relaying messages among the communication lines 2 and 3 and among the communication lines 3 and 3, processing for determining the presence or absence of a failure in the ECUs 40, and the like by reading out and executing a program 22a stored in the storage unit 22.

The storage unit 22 is configured using a non-volatile memory device such as, for example, Flash memory, Electrically Erasable Programmable Read Only Memory (EEPROM), or the like. The storage unit 22 stores various types of programs executed by the processing unit 21, and various types of data necessary for the processing by the processing unit 21. In the present embodiment, the storage unit 22 stores the program 22a executed by the processing unit 21, a relay table 22b for determining the relay destinations of data in relay processing, and a determination table 22c for determining failures in the ECUs 40.

Note that the program 22a may be written into the storage unit 22 at the manufacturing stage of the second relay device 20, for example. Additionally, for example, the program 22a may be distributed by a remote server device or the like, and the second relay device 20 may obtain the program 22a through communication and store the program 22a in the storage unit 22. Additionally, for example, the program 22a may be recorded into a recording medium 99 such as a memory card, an optical disk, or the like, and the second relay device 20 may then read out the program 22a from the recording medium 99 and store the program 22a in the storage unit 22. Additionally, for example, the program 22a recorded in the recording medium 99 may be read out by a writing device and written into the storage unit 22 of the second relay device 20. The program 22a may be provided by being distributed over a network, or may be provided by being recorded in the recording medium 99.

The relay table 22b is a table used for determining the relay destination of received data. For example, identification information such as a CANID or the like attached to the data and identification information identifying the communication line 2 or 3 serving as the relay destination are stored in the relay table 22b in association with each other.

The determination table 22c is a table for the second relay device 20 to determine the presence or absence of failures in the ECUs 40. The determination table 22c is a table in which the presence or absence of a failure in the ECU 40 is defined for a correspondence relationship between the data transmitted by the ECU 40 and the power consumption amount of the ECU 40. The second relay device 20 can determine whether or not there is a failure in an ECU 40 by referring to the determination table 22c on the basis of a result of determining one of, for example, a normal value, an abnormal value, a fail-safe value, or a communication interruption with respect to the transmitted data from the ECU 40, and a result of determining whether the consumed power amount of the ECU 40 is normal or abnormal. The determination table 22c will be described in detail later.

The first communication unit 23 is connected to the communication line 2, and communicates with the first relay device 10 over the communication line 2. In the present embodiment, the first communication unit 23 transmits and receives data according to a communication standard such as Ethernet, CAN, or the like. When the Ethernet communication standard is employed, the first communication unit 23 can be configured using an Integrated Circuit (IC) of the Ethernet PHYsical layer (PHY), for example. When the CAN communication standard is employed, the first communication unit 23 can be configured using a CAN controller IC, for example. The first communication unit 23 performs data transmission by outputting data supplied from the processing unit 21 to the communication line 2 as an electrical signal. Additionally, by sampling and obtaining the potential of the communication line 2, the first communication unit 23 converts an electrical signal on the communication line 2 into digital data, and supplies the converted data to the processing unit 21 as reception data.

In this example, the second relay device 20 includes three of the second communication units 24. Each second communication unit 24 is connected to a corresponding communication line 3, and communicates with the ECU 40 connected to that communication line 3. In the present embodiment, the second communication units 24 transmit and receive data according to the Ethernet or CAN communication standard. The second communication units 24 can be configured using, for example, Ethernet PHY or CAN controller ICs, for example. The second communication units 24 perform data transmission by outputting data supplied from the processing unit 21 to the communication lines 3 as electrical signals. By sampling and obtaining the potential of the communication lines 3, the second communication units 24 convert electrical signals on the communication lines 3 into digital data, and supply the converted data to the processing unit 21 as reception data.

The power relay unit 25 supplies (relays) power supplied from the power source 5 of the vehicle 1 to the various units within the second relay device 20 and to the ECUs 40. Note that the power supply paths from the power relay unit 25 to the various units within the second relay device 20 are not shown in this drawing. The power relay unit 25 converts the power supplied from the power source 5, which has, for example, a voltage value of 12 V, to power of 5 V, 3 V, or the like, and supplies the power to the various units in the second relay device 20 and the ECUs 40. The power relay unit 25 according to the present embodiment has a function for sensing the power consumption amount of each ECU 40 and a function for cutting off the supply of power to each ECU 40 individually. The power consumption amount of each ECU 40, sensed by the power relay unit 25, is communicated to the processing unit 21. The power relay unit 25 cuts off the supply of power to each ECU 40 individually in response to commands from the processing unit 21.

Additionally, by the processing unit 21 reading out and executing the program 22a stored in the storage unit 22, the second relay device 20 of the present embodiment causes the processing unit 21 to realize, as software, function blocks such as a communication relay unit 21a, a data determining unit 21b, a power determining unit 21c, a failure determining unit 21d, a cutoff unit 21e, a limiting unit 21f, and the like. The communication relay unit 21a performs processing of relaying data by transmitting data, which has been received by the first communication unit 23 or any of the second communication units 24, from another first communication unit 23 or second communication unit 24. The communication relay unit 21a obtains the CANID attached to the received data, refers to the relay table 22b in the storage unit 22, and finds a transmission destination associated with the CANID in the relay table 22b. The communication relay unit 21a supplies the data to the first communication unit 23 or the second communication unit 24 designated as the transmission destination in the relay table 22b, and causes the first communication unit 23 or the second communication unit 24 to transmit that data.

The data determining unit 21b determines whether the data transmitted by the ECU 40 for which the failure determination is to be made is a normal value, an abnormal value, a fail-safe value, or indicates a communication interruption. If the ECU 40 communicates according to the CAN communication standard, the data determining unit 21b determines whether or not the value stored in a data field of the transmitted data (transmitted message, transmitted frame) of the ECU 40 is a normal value, an abnormal value, or the like. The data determining unit 21b can determine whether or not this data is a fail-safe value on the basis of whether or not the value of the data from the ECU 40 is a specific value. The data determining unit 21b can determine whether this data is a normal value or an abnormal value on the basis of whether the value of the data is within a predetermined range. The data determining unit 21b can determine a communication interruption from the ECU 40 according to whether or not data that should be output in a predetermined cycle has been supplied by the ECU 40. Communication interruptions include not receiving any transmitted data from the ECU 40, as well as not receiving this data within a predetermined cycle in which the data should be transmitted.

The power determining unit 21c determines whether the power consumption amount of each ECU 40 is normal or abnormal by determining whether or not the power consumption amount of each ECU 40 communicated by the power relay unit 25 exceeds a threshold. Different values for the threshold for the determination may be used for each ECU 40, and these values are stored in the storage unit 22 in advance. Note that rather than simply comparing the power consumption amount with the threshold value, the power determining unit 21c may, for example, calculate a rate of change of an increase or decrease in the power consumption amount and determine whether or not this rate of change exceeds a threshold.

The failure determining unit 21d performs processing for determining whether or not there is a failure in an ECU 40 by referring to the determination table 22c stored in the storage unit 22 on the basis of a determination result for the transmitted data of the ECU 40 from the data determining unit 21b and a determination result for the power consumption amount of the ECU 40 from the power determining unit 21c.

The cutoff unit 21e performs processing for cutting off the supply of power as necessary for an ECU 40 determined by the failure determining unit 21d to have failed. The cutoff unit 21e supplies a cutoff command, specifying the ECU 40 for which the supply of power is to be cut off, to the power relay unit 25. The power relay unit 25 stops (cuts off) the supply of power to the specified ECU 40 in response to the cutoff command.

The limiting unit 21f performs processing for limiting the relay of the data transmitted by an ECU 40 as necessary for an ECU 40 determined by the failure determining unit 21d to have failed. For example, the limiting unit 21f sets a flag or the like to prohibit relaying in the relay table 22b for the CANID attached to the data transmitted by the ECU 40 determined to have failed. The communication relay unit 21a does not transmit, from the other communication lines 2 and 3, data to which is attached a CANID in which a flag prohibiting relay is set.

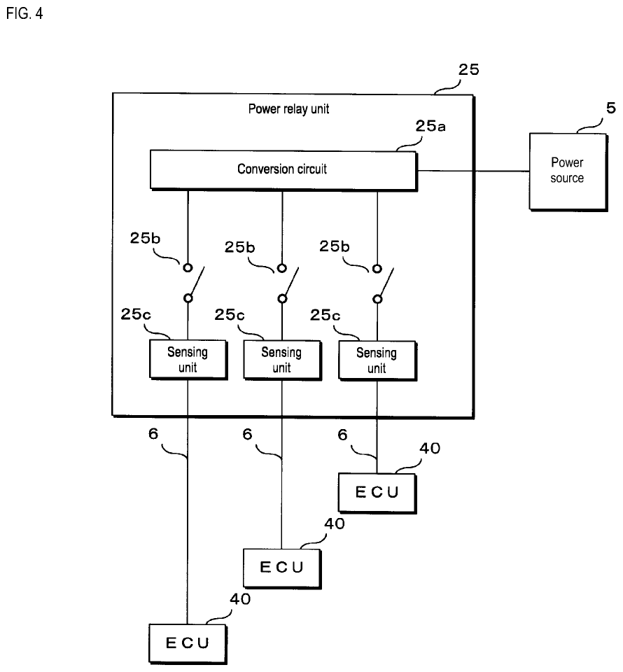

FIG. 4 is a block diagram illustrating the configuration of the power relay unit 25 according to the present embodiment. The power relay unit 25 included in the second relay device 20 according to the present embodiment is configured including a conversion circuit 25a, a plurality of switches 25b, and a plurality of sensing units 25c. The conversion circuit 25a is a circuit, such as a DC/DC converter or the like, for example, that converts the 12 V power supplied from the power source 5 into 5 V, 3 V, or the like and outputs the converted power. In this example, the power relay unit 25 supplies power to three ECUs 40, and an individual power supply path from the conversion circuit 25a to each ECU 40 is provided.

The switches 25b are configured using switching elements which can control the switching of the power relay unit 25 between energized and cut off, such as relays, semiconductor switches, or the like, for example. The power relay unit 25 in this example includes three switches 25b which can be controlled individually. Each switch 25b is provided in a corresponding power supply path from the conversion circuit 25a to an ECU 40, and can switch each power between energized and cut off.

The sensing units 25c are provided in respective power supply paths from the switches 25b to the ECUs 40, and sense the amounts of power supplied to the ECUs 40 via the corresponding power supply paths, i.e., the amount of power consumed by each ECU 40. The sensing units 25c sense the consumed power amounts of the ECUs 40 by obtaining the integral values of current flowing through the power supply paths, for example.

### Failure Determination Processing

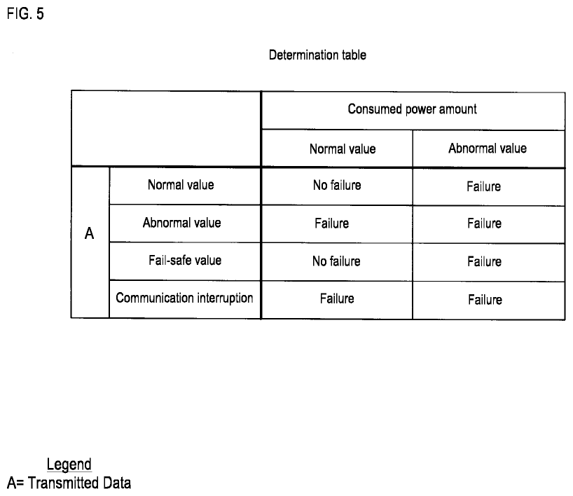

FIG. 5 is a schematic diagram illustrating an example of the determination table 22c according to the present embodiment. The determination table 22c stored in the storage unit 22 in the second relay device 20 is a table in which the transmission data of the ECU 40 and the consumed power amount of the ECU 40 are associated with the presence or absence of a failure in the ECU 40. In this example, the second relay device 20 determines whether the data transmitted by the ECU 40 is a normal value, an abnormal value, a fail-safe value, or indicates a communication interruption. Additionally, in this example, the second relay device 20 determines whether the consumed power amount of the ECU 40 is a normal value or an abnormal value. The second relay device 20 makes these determinations for each ECU 40 connected to the second relay device 20 itself.

For example, the second relay device 20 determines whether or not the value of the data is a normal value by comparing a value contained in data transmitted by the ECU 40 with a predetermined threshold and determining whether or not the value of the data is present within a range specified by the threshold. The fail-safe value is data transmitted in response to an abnormality or the like in the ECU 40, and a predetermined value is stored in the data. The second relay device 20 determines whether or not the value contained in the data corresponds to the fail-safe value by determining whether or not the value contained in the data matches the predetermined value serving as the fail-safe value. The second relay device 20 determines that the value contained in the data is an abnormal value when the value contained in the data is not a normal value or the fail-safe value. Additionally, the ECU 40 repeatedly transmits the data at a predetermined cycle, and the second relay device 20 determines that the communication of the ECU 40 has been interrupted when the next data is not received even after the predetermined cycle has passed from the previous data transmission.

For example, the second relay device 20 determines whether or not the consumed power amount of the ECU 40 is a normal value by obtaining a result of sensing the consumed power amount of the ECU 40 from the power relay unit 25 and determining whether or not the consumed power amount of the ECU 40 exceeds a predetermined threshold. Additionally, the second relay device 20 may determine whether or not the consumed power amount of the ECU 40 is an abnormal value by calculating a rate of change in the increase or decrease of the consumed power amount of the ECU 40, comparing the rate of change with a threshold, and determining whether or not the rate of change exceeds the threshold. The consumed power amount abnormality can include not only a situation where the consumed power amount continues to exceed the threshold, but also a situation where the consumed power amount exceeds the threshold only for a short period of time.

According to the determination table 22c in this example, when the transmission data of the ECU 40 is a normal value or the fail-safe value, and the consumed power amount of the ECU 40 is a normal value, the second relay device 20 determines that the ECU 40 does not have a failure (has not failed). When the transmission data from the ECU 40 is an abnormal value or communication with the ECU 40 has been interrupted, the second relay device 20 determines that the ECU 40 has a failure (has failed) regardless of whether the consumed power amount of the ECU 40 is a normal value or an abnormal value). When the consumed power amount of the ECU 40 is an abnormal value, the second relay device 20 determines that the ECU 40 has failed regardless of the value of the transmission data of the ECU 40. Note that the determination table 22c in this example is merely an example and is not limited thereto, and the correspondence between the transmission data, the consumed power amount, and the presence or absence of a failure is determined as appropriate in accordance with the configuration of the ECU 40, the vehicle-mounted communication system, or the like. The determination table 22c may also have different content for each ECU 40.

The second relay device 20 according to the present embodiment cuts off the supply of power to the ECU 40 when it is determined that there is a failure on the basis of the consumed power amount of the ECU 40 being an abnormal value. By switching the switch 25b provided in the power supply path to an ECU 40 for which the consumed power amount is determined to be an abnormal value from an energized state to a cut-off state, the second relay device 20 cuts off the supply of power to that ECU 40.

When it is determined that there is a failure on the basis of the transmission data of the ECU 40 being an abnormal value, the second relay device 20 according to the present embodiment limits (prohibits) the further relay of data transmitted by that ECU 40, including the transmission data determined to be an abnormal value, to other ECUs 40 or the first relay device 10. Additionally, when it is determined that the transmission data of the ECU 40 is the fail-safe value, the second relay device 20 may perform processing in accordance with that fail-safe value. The processing performed at this time is determined as appropriate in accordance with the configuration of the ECU 40, the vehicle-mounted communication system, or the like.

When it is determined that the ECU 40 has failed, the second relay device 20 notifies a user of the vehicle 1, the server device 50, or the like. At this time, the second relay device 20 does not absolutely need to make a notification in response to the determination of a failure in the ECU 40, and may make the notification as necessary, e.g., making the notification in cases of a serious emergency. When making the notification as necessary, the second relay device 20 stores conditions for making the notification in association with factors of the failure and the like, for each ECU 40, for example. For example, the conditions for making the notification can be that the consumed power amount (or current amount) is an abnormal value in an ECU 40 related to a drive motor, a battery, or the like, and furthermore, conditions such as the consumed power amount exceeding the threshold by 20% or more may be added. Additionally, for example, the conditions for the notification can be that communication is interrupted for an ECU 40 related to the engine, autonomous driving, or the like. The second relay device 20 determines whether or not the factors of the failure in the ECU 40 match the conditions for the notification, and makes the notification when the factors match the conditions for the notification.

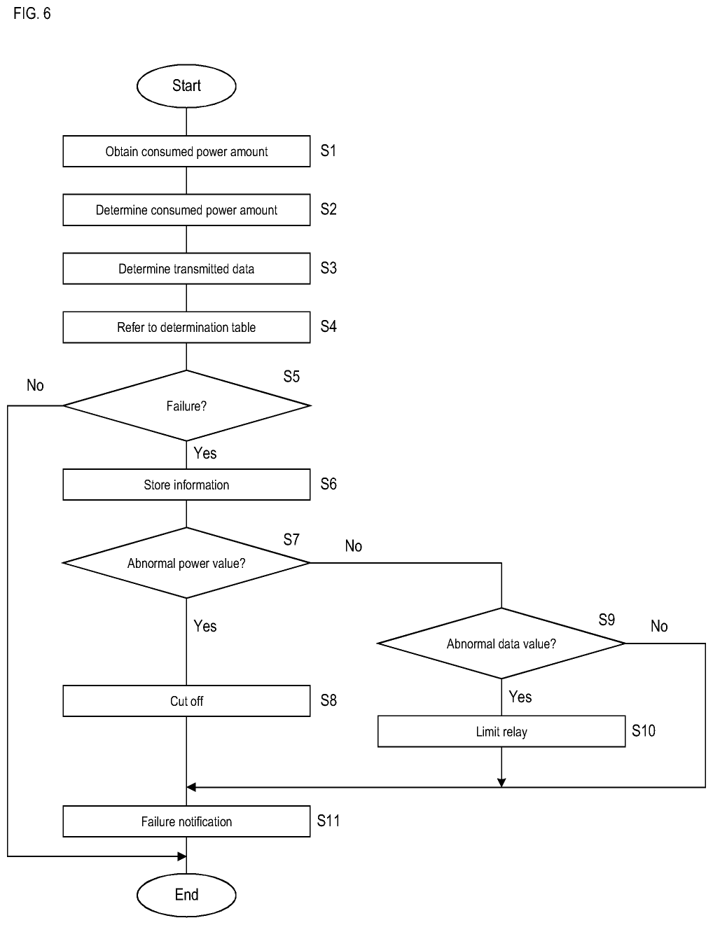

FIG. 6 is a flowchart illustrating the sequence of the failure determination processing performed by the second relay device 20 according to the present embodiment. The processing illustrated in this flowchart is performed for each ECU 40, and is performed repeatedly every predetermined cycle. The power determining unit 21c of the processing unit 21 of the second relay device 20 according to the present embodiment obtains the consumed power amount of the ECU 40 sensed by the power relay unit 25 (step S1). The power determining unit 21c performs processing for comparing the obtained consumed power amount with a predetermined threshold and determining whether or not the consumed power amount of the ECU 40 is normal (step S2). The data determining unit 21b of the processing unit 21 performs processing for determining whether or not the data from the ECU 40 is normal on the basis of a value contained in the data from the ECU 40, received by the second communication unit 24, whether or not data has been received, and the like (step S3).

The failure determining unit 21d of the processing unit 21 refers to the determination table 22c stored in the storage unit 22 on the basis of the result of the determination pertaining to the consumed power, made in step S2, and the result of the determination pertaining to the transmission data, made in step S3 (step S4). The failure determining unit 21d determines the presence or absence of a failure in the ECU 40 on the basis of the result of referring to the determination table 22c (step S5). If it is determined that there is no failure (S5: NO), the processing unit 21 ends the failure determination processing. If it is determined that there is a failure (S5: YES), the processing unit 21 stores information pertaining to the failure of the ECU 40, e.g., information on the consumed power amount, the transmission data, and the like when it was determined that there is a failure, in the storage unit 22 (step S6).

The cutoff unit 21e of the processing unit 21 determines whether or not the factor for determining the failure in the ECU 40 is due to an abnormal value for the consumed power amount (step S7). If the factor for the failure is that the consumed power amount is an abnormal value (S7: YES), the cutoff unit 21e cuts off the supply of power to the ECU 40 (step S8) by supplying, to the power relay unit 25, a command to cut off the supply of power to the ECU 40, and then moves the processing to step S11.

If the factor for the failure is not that the consumed power amount is an abnormal value (S7: NO), the limiting unit 21f of the processing unit 21 determines whether or not the factor for determining the failure in the ECU 40 is due to an abnormal value being contained in the transmission data of the ECU 40 (step S9). If the factor for the failure is that the transmission data has an abnormal value (S9: YES), the limiting unit 21f limits the relaying by the ECU 40 that transmitted the data containing the abnormal value (step S10), and then moves the processing to step S11. If the factor for the failure is not that the transmission data has an abnormal value (S9: NO), the limiting unit 21f moves the processing to step S11. The processing unit 21 notifies the user of the vehicle 1, the server device 50, or the like of the failure in the ECU 40 as necessary (step S11), and then ends the failure determination processing.

### Conclusion

In the vehicle-mounted communication system according to the present embodiment having the above-described configuration, power from the power source 5, which is a battery, an alternator, or the like mounted in the vehicle 1, is supplied to the second relay device 20, and the second relay device 20 relays the power from the power source 5 to the ECU 40. The second relay device 20 relays data transmitted from the ECU 40 to other devices and data transmitted from other devices to the ECU 40. In other words, the second relay device 20 according to the present embodiment is a device that relays power and relays communication. The second relay device 20 senses the consumed power amount of the ECU 40 and determines the presence or absence of a failure in the ECU 40 in accordance with the data transmitted by the ECU 40 and the power consumption amount of the ECU 40. This is expected to enable the second relay device 20, which relays power and data to the ECU 40, to accurately determine the presence or absence of a failure in the ECU 40.

When the power consumption amount of the ECU 40 is an abnormal value, the second relay device 20 according to the present embodiment determines that the ECU 40 has failed regardless of whether the data transmitted by the ECU 40 is a normal value, an abnormal value, or the like. The second relay device 20 determines that the ECU 40 has failed when the consumed power amount of the ECU 40 is a normal value and the data transmitted by the ECU 40 is an abnormal value. In contrast, the second relay device 20 determines that the ECU 40 has not failed when the consumed power amount of the ECU 40 is a normal value and the data transmitted by the ECU 40 is a normal value. This is expected to enable the second relay device 20 to accurately determine the presence or absence of a failure in the ECU 40 on the basis of the data transmitted by the ECU 40 and the power consumption amount of the ECU 40.

The second relay device 20 according to the present embodiment cuts off the supply of power to the ECU 40 when it is determined that there is a failure on the basis of the power consumption amount of the ECU 40 being an abnormal value. This makes it possible to prevent abnormal power consumption by the ECU 40 determined to have failed and thus prevent other devices mounted in the vehicle 1 from being negatively affected.

The second relay device 20 according to the present embodiment limits the relay of data from the ECU 40 to other devices when it is determined that there is a failure on the basis of the data transmitted by the ECU 40 being an abnormal value. This makes it possible to prevent the other devices from malfunctioning or the like due to the abnormal data transmitted by the ECU 40 determined to have failed.

The second relay device 20 according to the present embodiment determines that the ECU 40 has not failed when the power consumption amount of the ECU 40 is a normal value and the data transmitted by the ECU 40 is a fail-safe value. The ECU 40 transmitting data having a fail-safe value indicates that even if some abnormality has occurred, the ECU 40 has handled the abnormality and is outputting a fail-safe value, and it is therefore highly likely that no failure is occurring.

The second relay device 20 according to the present embodiment determines that the ECU 40 has failed when the power consumption amount of the ECU 40 is a normal value and no data is received from the ECU 40. In a state of communication interruption, in which the second relay device 20 does not receive data from the ECU 40, it is highly likely that some kind of abnormality has occurred in the ECU 40.

In the present embodiment, failures are determined by classifying the data transmitted by the ECU 40 into four types, namely a normal value, an abnormal value, a fail-safe value, or a communication interruption; however, the classification of the data is not limited to these four types, and the values may be further classified into different types. Additionally, in the present embodiment, the second relay device 20 mounted in the vehicle 1 performs the failure determination, but the configuration is not limited thereto, and another device mounted in the vehicle 1 may perform the failure determination, or a server device or the like installed outside the vehicle 1 may perform the same kind of failure determination. Additionally, in the present embodiment, the second relay device 20 determines the presence or absence of a failure by referring to the determination table 22c stored in the storage unit 22 in advance, but the determination may be made without using the determination table 22c. A sequence of the failure determination processing when the determination table 22c is not used will be described in the variation below.

### Variation

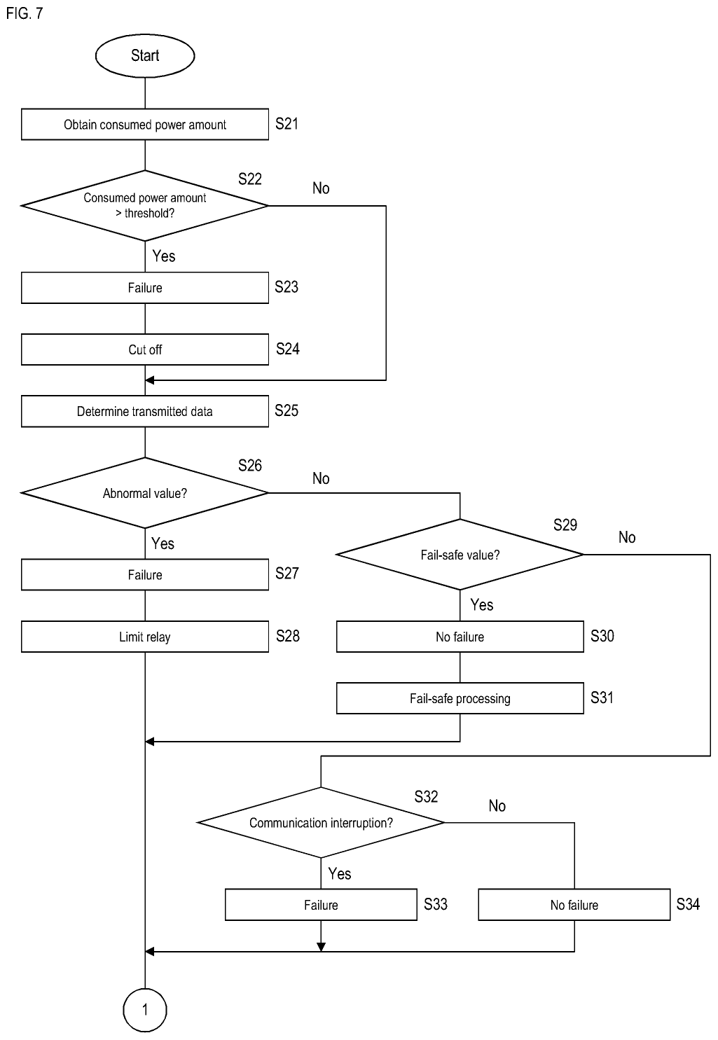

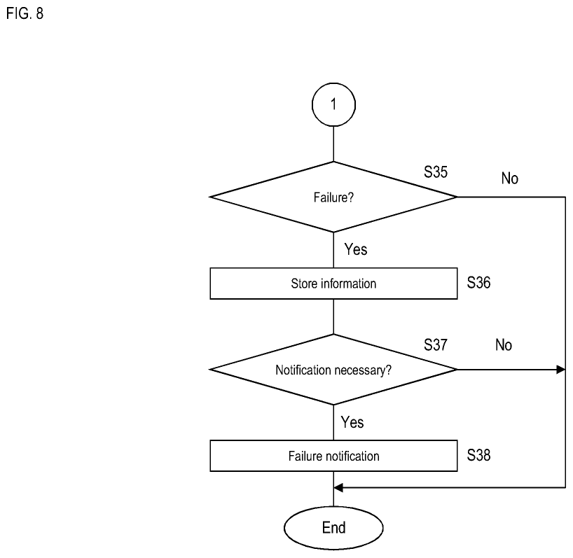

FIGS. 7 and 8 are flowcharts illustrating the sequence of the failure determination processing performed by the second relay device 20 according to a variation. The processing illustrated in this flowchart is performed for each ECU 40, and is performed repeatedly every predetermined cycle. The power determining unit 21c of the processing unit 21 of the second relay device 20 according to the variation obtains the consumed power amount of the ECU 40 sensed by the power relay unit 25 (step S21). The power determining unit 21c compares the obtained consumed power amount with a predetermined threshold and determines whether or not the consumed power amount of the ECU 40 exceeds the threshold (step S22). If it is determined that the consumed power amount of the ECU 40 exceeds the threshold (S22: YES), the failure determining unit 21d of the processing unit 21 determines that the ECU 40 has failed (step S23). The cutoff unit 21e of the processing unit 21 cuts off the supply of power to the ECU 40 (step S24) by supplying, to the power relay unit 25, a command to cut off the supply of power to the ECU 40, and then moves the processing to step S25. If the consumed power amount of the ECU 40 does not exceed the threshold (S22: NO), the processing unit 21 moves the processing to step S25.

The data determining unit 21b of the processing unit 21 determines whether or not a value contained in the data from the ECU 40, received by the second communication unit 24, is an abnormal value (step S26). If the value included in the data is an abnormal value (S26: YES), the failure determining unit 21d determines that the ECU 40 has failed (step S27). The limiting unit 21f of the processing unit 21 limits the relay of the data transmitted by the ECU 40 (step S28) and then moves the processing to step S35.

If the value contained in the data transmitted from the ECU 40 is not an abnormal value (S26: NO), the data determining unit 21b determines whether or not the value contained in the data is a fail-safe value (step S29). If the value contained in the data is a fail-safe value (S29: YES), the failure determining unit 21d determines that the ECU 40 has not failed (step S30). In accordance with the fail-safe value contained in the data, the processing unit 21 performs processing corresponding to the fail-safe value as necessary (fail-safe processing) (step S31), and then moves the processing to step S35.

If the value contained in the data transmitted from the ECU 40 is not a fail-safe value (S29: NO), the data determining unit 21b determines whether or not the ECU 40 is in a state of communication interruption (step S32). If in a state of communication interruption (S32: YES), the failure determining unit 21d determines that the ECU 40 has failed (step S33), and moves the processing to step S35. If not in a state of communication interruption (S32: NO), the failure determining unit 21d determines that the ECU 40 has not failed (step S34), and moves the processing to step S35.

The processing unit 21 determines whether or not the ECU 40 has failed through the above-described processing (step S35). If it is determined that the ECU 40 has not failed (S35: NO), the processing unit 21 ends the failure determination processing. If it is determined that the ECU 40 has failed (S35: YES), the processing unit 21 stores information pertaining to the failure of the ECU 40, e.g., information on the consumed power amount, the transmission data, and the like when it was determined that there is a failure, in the storage unit 22 (step S36).

The processing unit 21 determines whether or not it is necessary to make a notification regarding the failure in the ECU 40 (step S37). If it is necessary to make a notification (S37: YES), the processing unit 21 makes a notification of the failure in the ECU 40 by displaying a message in a display or the like provided in the vehicle 1, by transmitting a message to the server device 50 via the wireless communication device 30, or the like (step S38), and then ends the failure determination processing. If it is not necessary to make a notification (S37: NO), the processing unit 21 ends the failure determination processing.

### Second Embodiment

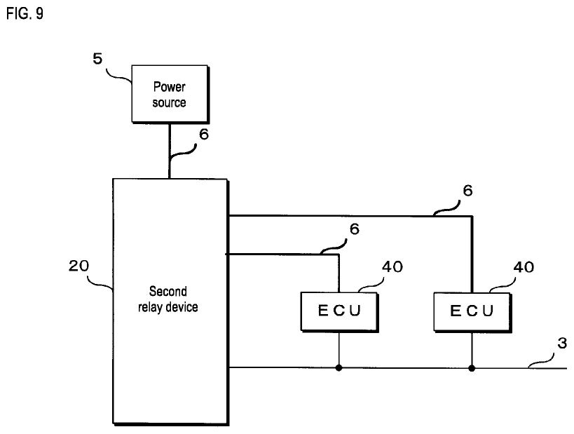

FIG. 9 is a schematic diagram illustrating an overview of a vehicle-mounted communication system according to a second embodiment. FIG. 9 illustrates communication paths and power supply paths between the second relay device 20 and two of the ECUs 40, focusing on one of the second relay devices 20 included in the vehicle-mounted communication system. The second relay device 20 and the ECUs 40 according to the second embodiment communicate over a bus-type communication line 3. Accordingly, the second relay device 20 and the two ECUs 40 are connected to a common communication line 3. However, the second relay device 20 and the two ECUs 40 are connected over individual power lines 6, respectively. The second relay device 20 can supply power to the ECUs 40 individually over the power lines 6, detect the consumed power amounts of the ECUs 40 individually, and cut off the supply of power to the ECUs 40 individually as well.

In a network configuration in which a plurality of ECUs 40 are connected to a common communication line 3 as in the vehicle-mounted communication system according to the second embodiment, a single ECU 40 failing and transmitting abnormal data can cause the other ECUs 40 connected to the common communication line 3 to malfunction or the like, resulting in the other ECUs 40 transmitted abnormal data as well. Accordingly, the second relay device 20 according to the second embodiment first cuts off the supply of power to an ECU 40 for which the consumed power amount is an abnormal value, and then stops the operations of the ECU 40 that has failed. The second relay device 20 stops the operations of all the ECUs 40, among the plurality of ECUs 40 connected to the common communication line 3, for which the consumed power amount is an abnormal value, which reduces the impact on the other normal ECUs 40. Then, for the remaining ECUs 40 connected to the communication line 3, i.e., the one or more ECUs 40 for which the supply of power is not cut off, the second relay device 20 determines the presence or absence of a failure based on the data transmitted by those ECUs 40.

In this manner, the second relay device 20 according to the second embodiment can be expected to increase the accuracy of determining a failure in the ECUs 40 based on the transmitted data by stopping, in advance, the ECUs 40 determined to have failed on the basis of the consumed power amount.

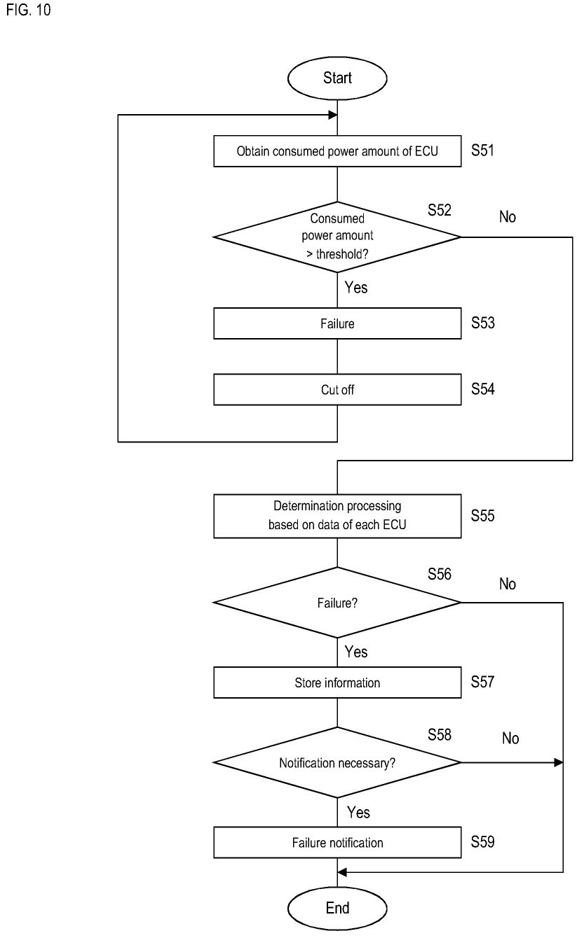

FIG. 10 is a flowchart illustrating the sequence of failure determination processing performed by the second relay device 20 according to the second embodiment. The processing illustrated in this flowchart is processing for determining failures for the plurality of ECUs 40 connected to the second relay device 20 by the common communication line 3, and is processing performed repeatedly every predetermined cycle for each of the communication lines 3. The power determining unit 21c of the processing unit 21 of the second relay device 20 according to the second embodiment obtains the consumed power amount sensed by the power relay unit 25, for the plurality of ECUs 40 connected to a single communication line 3 (step S51). The power determining unit 21c compares the obtained plurality of consumed power amounts with a predetermined threshold and determines whether or not at least one of the consumed power amounts exceeds the threshold (step S52).

If there is at least one consumed power amount that exceeds the threshold (S52: YES), the power determining unit 21c determines that the ECU 40 having the consumed power amount that exceeds the threshold has failed (step S53). The cutoff unit 21e of the processing unit 21 cuts off the supply of power to the ECU 40 for which the consumed power amount exceeds the threshold (step S54) by supplying, to the power relay unit 25, a command to cut off the supply of power to that ECU 40, and then moves the processing to step S51. Note that if there are a plurality of ECUs 40 for which the consumed power amount exceeds the threshold, the cutoff unit 21e may, for example, cut off the supply of power to all the ECUs 40 for which the consumed power amount exceeds the threshold, or may cut off the supply of power to one of the ECUs 40, e.g., the ECU 40 having the highest consumed power amount.

If there is not even one consumed power amount that exceeds the threshold (S52: NO), the power determining unit 21c moves the processing to step S55. The case where this branch is selected can include a case where there is no failure and the consumed power amount does not exceed the threshold for all the ECUs 40 connected to the communication line 3, and a case where there are no more ECUs 40 having a consumed power amount exceeding the threshold because the supply of power to the ECUs 40 having consumed power amounts exceeding the threshold has been cut off.

The data determining unit 21b of the processing unit 21 performs processing for determining whether the data from each ECU 40, received by the second communication unit 24, is a normal value, an abnormal value, or the like (step S55). The failure determining unit 21d of the processing unit 21 determines whether or not at least one of the ECUs 40 has failed on the basis of the result of the determination based on the consumed power amount, in steps S51 to S54, and the result of the determination in step S55 (step S56). If there are no failures in all of the ECUs 40 (S56: NO), the processing unit 21 ends the failure determination processing.

If there is a failure in at least one of the ECUs 40 (S56: YES), the processing unit 21 stores information about the failure in the ECU 40 in the storage unit 22 (step S57). The processing unit 21 determines whether or not it is necessary to make a notification regarding the failure in the ECU 40 (step S58). If it is necessary to make a notification (S58: YES), the processing unit 21 makes a notification of the failure in the ECU 40 by displaying a message in a display or the like provided in the vehicle 1, by transmitting a message to the server device 50 via the wireless communication device 30, or the like (step S59), and then ends the failure determination processing. If it is not necessary to make a notification (S58: NO), the processing unit 21 ends the failure determination processing.

In the vehicle-mounted communication system according to the second embodiment having the above-described configuration, the second relay device 20 and the plurality of ECUs 40 are connected by a common communication line 3, and the second relay device 20 and the plurality of ECUs 40 are connected by individual power lines 6. The second relay device 20 cuts off the supply of power to ECUs 40 for which the consumed power amount is an abnormal value exceeding a threshold, and then determines the presence or absence of a failure based on the reception data from the ECUs 40. This makes it possible to prevent abnormal data transmitted by an ECU 40 which has failed from negatively affecting data transmitted by other normal ECUs 40 and reducing the accuracy of failure determination based on the transmitted data of the ECUs 40 by the second relay device 20.

Because other configurations of the vehicle-mounted communication system according to the second embodiment are the same as in the vehicle-mounted communication system according to the first embodiment, like reference signs are given to like elements, and detailed descriptions thereof will not be given.

Each device in the vehicle-mounted communication system includes a computer configured including a microprocessor, ROM, RAM, and the like. An arithmetic processing unit such as a microprocessor or the like may read out, from a storage unit such as ROM, RAM, or the like, a computer program including some or all of the steps in the sequence charts or flowcharts such as those in FIGS. 6 to 8 and 10, and execute the computer program. The computer programs of the plurality of devices can be installed from an external server device or the like. Additionally, the computer programs of the plurality of devices are distributed in a state stored in a recording medium such as a CD-ROM, a DVD-ROM, semiconductor memory, or the like.

The embodiments disclosed here are intended to be in all ways exemplary and in no ways limiting. The scope of the present disclosure is defined not by the foregoing descriptions but by the scope of the claims, and is intended to include all changes equivalent in meaning and scope of the claims.

1. A vehicle-mounted relay device, comprising:
a power relay unit that relays power from a power source mounted in a vehicle to a vehicle-mounted device;
a sensing unit that senses a power consumption amount of the vehicle-mounted device;
a communication relay unit that relays transmission and reception of data to and from the vehicle-mounted device; and
a failure determining unit that determines the presence or absence of a failure in the vehicle-mounted device in accordance with data transmitted by the vehicle-mounted device and the power consumption amount sensed by the sensing unit.

2. The vehicle-mounted relay device according to claim 1,
wherein the failure determining unit:
determines that a failure is present when the power consumption amount sensed by the sensing unit is an abnormal value, regardless of whether or not the data transmitted by the vehicle-mounted device is a normal value,
determines that a failure is present when the power consumption amount sensed by the sensing unit is a normal value and the data transmitted by the vehicle-mounted device is an abnormal value, and
determines that a failure is absent when the power consumption amount sensed by the sensing unit is a normal value and the data transmitted by the vehicle-mounted device is a normal value.

3. The vehicle-mounted relay device according to claim 2, further comprising:
a cutoff unit that cuts off the power to the vehicle-mounted device from the power relay unit when a failure is determined to be present on the basis of the power consumption amount sensed by the sensing unit being an abnormal value.

4. The vehicle-mounted relay device according to claim 2, further comprising:
a limiting unit that limits the relay of data from the vehicle-mounted device to another device when a failure is determined to be present on the basis of the data transmitted by the vehicle-mounted device being an abnormal value.

5. The vehicle-mounted relay device according to claim 1, wherein the failure determining unit determines that a failure is absent when the power consumption amount sensed by the sensing unit is a normal value and the data transmitted by the vehicle-mounted device is a fail-safe value.

6. The vehicle-mounted relay device according to claim 1, wherein the failure determining unit determines that a failure is present when the power consumption amount sensed by the sensing unit is a normal value and data from the vehicle-mounted device is not received.

7. A computer program that causes a computer, which includes a power relay unit that relays power from a power source mounted in a vehicle to a vehicle-mounted device and a communication relay unit that relays transmission and reception of data to and from the vehicle-mounted device, to execute the processing of:
obtaining a result of sensing a power consumption amount of the vehicle-mounted device; and
determining the presence or absence of a failure in the vehicle-mounted device in accordance with data transmitted by the vehicle-mounted device and the power consumption amount obtained.

8. A failure determining method, comprising:
relaying power from a power source mounted in a vehicle to a vehicle-mounted device;
sensing a power consumption amount of the vehicle-mounted device;
relaying transmission and reception of data to and from the vehicle-mounted device; and
determining the presence or absence of a failure in the vehicle-mounted device in accordance with data transmitted by the vehicle-mounted device and the power consumption amount sensed.

9. The vehicle-mounted relay device according to claim 3, further comprising:
a limiting unit that limits the relay of data from the vehicle-mounted device to another device when a failure is determined to be present on the basis of the data transmitted by the vehicle-mounted device being an abnormal value.

10. The vehicle-mounted relay device according to claim 2, wherein the failure determining unit determines that a failure is absent when the power consumption amount sensed by the sensing unit is a normal value and the data transmitted by the vehicle-mounted device is a fail-safe value.

11. The vehicle-mounted relay device according to claim 3, wherein the failure determining unit determines that a failure is absent when the power consumption amount sensed by the sensing unit is a normal value and the data transmitted by the vehicle-mounted device is a fail-safe value.

12. The vehicle-mounted relay device according to claim 4, wherein the failure determining unit determines that a failure is absent when the power consumption amount sensed by the sensing unit is a normal value and the data transmitted by the vehicle-mounted device is a fail-safe value.

13. The vehicle-mounted relay device according to claim 2, wherein the failure determining unit determines that a failure is present when the power consumption amount sensed by the sensing unit is a normal value and data from the vehicle-mounted device is not received.

14. The vehicle-mounted relay device according to claim 3, wherein the failure determining unit determines that a failure is present when the power consumption amount sensed by the sensing unit is a normal value and data from the vehicle-mounted device is not received.

15. The vehicle-mounted relay device according to claim 4, wherein the failure determining unit determines that a failure is present when the power consumption amount sensed by the sensing unit is a normal value and data from the vehicle-mounted device is not received.

16. The vehicle-mounted relay device according to claim 5, wherein the failure determining unit determines that a failure is present when the power consumption amount sensed by the sensing unit is a normal value and data from the vehicle-mounted device is not received.
